(19) United States
(12) Patent Application Publication
(10) Pub. No.: US 2016/0272918 A1
(43) Pub. Date: Sep. 22, 2016

(54) SYNTHETIC ANTI-FRICTION & EXTREME PRESSURE METAL CONDITIONER COMPOSITION AND METHOD OF PREPARATION

(71) Applicant: DYNATEC, LLC, Falls Church, VA (US)

(72) Inventor: John ROBERTS, Falls Church, VA (US)

(73) Assignee: DYNATEC, LLC, Falls Church, VA (US)

(21) Appl. No.: 15/072,561

(22) Filed: Mar. 17, 2016

Related U.S. Application Data
(60) Provisional application No. 62/134,874, filed on Mar. 18, 2015.

(51) Int. Cl. C10M 161/00; C10M 135/18; C10M 143/00; F02B 77/02; C10M 129/72; C10M 129/26; C10M 129/40; C10M 137/10; C10M 129/70

(52) U.S. Cl. CPC C10M 161/00; C10M 137/10; C10M 135/18; C10M 143/00; C10M 129/70; C10M 129/72; C10M 129/26; C10M 129/40; F02B 77/02

(57) ABSTRACT

A chemical composition for conditioning metal that may, when applied to a metal surface, bond to that surface at the atomic level, thereby creating a complex metal compound having a low shear and a low coefficient of friction. Metal conditioner may, when in use, possess substantial extreme pressure, anti-friction, and anti-wear properties.

### CROSS-REFERENCE TO RELATED APPLICATIONS

This application claims priority from U.S. Provisional Patent Application No. 62/134,874, filed on Mar. 31, 2015, entitled “Synthetic Anti-Friction & Extreme Pressure Metal Conditioner Composition and Method of Preparation,” the entire contents of which are hereby incorporated by reference.

### BACKGROUND

Frequently, users may find that untreated metal does not exhibit the properties that they would like it to. For example, a bare metal surface may not properly receive primer or paint, and a user that attempts to paint such a surface may find that their primer or paint does not properly adhere to the metal. Other users may find that moving metal component parts in contact with each other exhibit undesirable levels of heat or friction, and may wish to reduce this in order to save energy or obtain better performance.

A number of formulations for metal conditioners are known and in use today. Broadly, in chemistry, a “conditioner” may be any treatment chemical that improves the quality of some other material, and as such metal conditioner formulations may have a number of different uses. A common application for some metal conditioners is improving paint adhesion; many metal conditioners include or comprise an acid etchant, such as phosphoric acid, that when applied to a metal surface will remove surface corrosion and microscopically roughen the surface. Other metal conditioners may include a surfactant that may be used to remove oil or other debris from the surface of the metal that would otherwise be left in place to be painted over.

Metal conditioning also sees use in industrial and automotive applications. A common use of metal conditioning in these applications is friction reduction; many metal conditioner products advertise that they are able to reduce the heat and friction between moving metal component parts of a machine without changing the tolerance of the parts or causing interference with the operation of the machine. These conditioners may be used in, for example, a vehicle drive train in order to improve performance.

However, existing anti-friction metal conditioning treatments are not without their downsides. Many such metal conditioners are derived from chlorinated compounds, and function by oxidizing the outer layer of a treated metal surface to form a sacrificial layer. This layer, which often has lubricating properties, is then worn away as the machine operates. This can result in substantial wear to any metal component parts treated with the metal conditioner. The use of highly reactive chlorinated compounds in these conditioners may also interfere with or reduce the effect of existing lubricants, and may present a potential risk of harm to a user.

### SUMMARY

According to one exemplary embodiment, a chemical composition for conditioning metal may be described. Metal conditioner may, when applied to a metal surface, bond to that surface at the atomic level, thereby creating a complex metal compound having a low shear and a low coefficient of friction. Metal conditioner may, when in use, possess substantial extreme pressure, anti-friction, and anti-wear properties.

In an exemplary embodiment, a chemical composition for conditioning metal may comprise: a hydraulic oil additive substantially comprising zinc alkydithiophosphate; a hydrocarbon base fluid substantially comprising polyalphaolefin; a viscosity improver substantially comprising a linear olefin copolymer; a lubricity and wetting additive substantially comprising a low viscosity fatty methyl ester; an antioxidant; a polyol ester; and a mixture of bismuth neodecanoate and bismuth carboxylate. In some exemplary embodiments, the chemical composition may comprise: between 0.28 and 0.48 weight percent of the hydraulic oil additive substantially comprising zinc alkydithiophosphate; between 25.0 and 35.0 weight percent of the hydrocarbon base fluid substantially comprising polyalphaolefin; between 2.5 and 5.0 weight percent of the viscosity improver substantially comprising a linear olefin copolymer; between 25.0 and 35.0 weight percent of the lubricity and wetting additive substantially comprising a low viscosity fatty methyl ester; between 3.5 and 6.5 weight percent of the antioxidant; between 2.5 and 4.5 weight percent of the polyol ester; and between 23.0 and 37.0 weight percent of the mixture of bismuth neodecanoate and bismuth carboxylate.

In another exemplary embodiment, a metal conditioner composition substantially as described above may be mixed with a quantity of vehicular oil, for example engine oil. The resulting composition may comprise: at least one of engine oil, transmission fluid, or gear oil; and a metal conditioner composition, the metal conditioner composition comprising: a hydraulic oil additive substantially comprising zinc alkydithiophosphate; a hydrocarbon base fluid substantially comprising polyalphaolefin; a viscosity improver substantially comprising a linear olefin copolymer; a lubricity and wetting additive substantially comprising a low viscosity fatty methyl ester; an antioxidant; a polyol ester; and a mixture of bismuth neodecanoate and bismuth carboxylate.

In another exemplary embodiment, a method of decreasing friction and wear in an engine of a vehicle may be described. Such a method may comprise: adding to engine oil of the vehicle a metal conditioner composition, wherein the metal conditioner composition comprises: a hydraulic oil additive substantially comprising zinc alkydithiophosphate; a hydrocarbon base fluid substantially comprising polyalphaolefin; a viscosity improver substantially comprising a linear olefin copolymer; a lubricity and wetting additive substantially comprising a low viscosity fatty methyl ester; an antioxidant; a polyol ester; and a mixture of bismuth neodecanoate and bismuth carboxylate.

### BRIEF DESCRIPTION OF THE FIGURES

A more complete appreciation of the present invention and many of the attendant advantages thereof will be readily understood as the same becomes better understood by reference to the following detailed description when considered in connection with the accompanying drawings, wherein:

FIG. 1 depicts an exemplary embodiment of the four-ball wear test method that may be used in testing lubricants and lubricant additives.

FIG. 2 depicts the exemplary results of a four-ball wear test for MOBIL 1 10W-30 without an anti-friction metal conditioner having been added to the composition.

FIG. 3 depicts the exemplary results of a four-ball wear test for MOBIL 1 10W-30 with an anti-friction metal conditioner having been added to the composition.

FIG. 4 depicts the exemplary results of a four-ball wear test for SHELL SAE 10W-30 without an anti-friction metal conditioner having been added to the composition.

FIG. 5 depicts the exemplary results of a four-ball wear test for SHELL SAE 10W-30 with an anti-friction metal conditioner having been added to the composition.

FIG. 6 depicts an exemplary embodiment of an apparatus for performing a Falex Pin and Vee Block Extreme Pressure Test.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

A chemical composition for conditioning metal to have desirably low levels of surface friction may be provided. Composition may be a fully synthetic hydrocarbon, and may include a negatively-charged or negatively-polarized component such that when applied to a metal surface, elements of the composition tend to be attracted to the surface of the metal. According to an exemplary embodiment, elements of the composition may react and form covalent bonds with the metal surface.

According to such an embodiment, this may treat the metal surface with a complex metal compound having desirable properties. For example, this complex metal compound may have a much lower shear, which may in turn cause the complex metal compound to exhibit a much lower coefficient of friction than the original metal. This may be a desirable treatment for metal parts or components that are used in applications in which low friction, low wear, low operating temperature, or other similar properties are advantageous. For example, an industrial gear box in which the surfaces of gear components have been treated with such a composition may exhibit superior performance and may require less maintenance or replacement of parts.

An exemplary composition of a metal conditioner may be disclosed in table 1 and may be made by combining the following components in the proportions stated below.

TABLE 1
Anti-Friction Metal Conditioner Exemplary Composition

| Manufacturer | Product | Composition (wt %) |
|---|---|---|
| Lubrizol | 5178F | 0.28-0.48 |
| Ineos | Durasyn 166X | 25.0-35.0 |
| Chevron | Paratone 68530 | 2.5-5.0 |
| Dover Chemical | ME 165 | 25.0-35.0 |
| RT Vanderbilt | Vanlube 73 | 3.5-6.5 |
| BASF | Synative ES2939 | 2.5-4.5 |
| Shepherd Chemical | BiLube 8109 | 23.0-37.0 |

Alternative compositions may also be envisioned. For example, some embodiments may have relative compositions different from those shown; an exemplary composition may have a higher weight percent of one component chemical and a lower weight percent of a second component chemical. Equivalent or substantially equivalent component chemicals may also be substituted for chemicals within a composition. For example, if an embodiment of the metal conditioner is specified to use a quantity of CHEVRON PARATONE 68530 as a viscosity improver but the continued use of CHEVRON PARATONE 68530 becomes undesirable in the future—due to, for example, the manufacturer stopping production—an alternative viscosity improver may be substituted instead. Appropriate substitutions may be appreciated by one of skill in the art.

Turning now to the exemplary embodiment displayed in Table 1, LUBRIZOL 5178F may be a hydraulic oil additive substantially comprising zinc alkydithiophosphate and having certain antiwear properties. Specifically, it may offer good thermal and oxidative stability, good hydrolytic stability, good demulsibility, good rust protection characteristics, and low filter blockage tendency. Similar chemicals or compositions offering similar performance may also be substituted. It may have the following properties:

TABLE 2
Lubrizol 5178F Physical Properties

| Property | Lubrizol 5178F |
|---|---|
| FLASH POINT, C., PMCC | 100-120 |
| LBS PER U.S. GAL @ 15.6 C. | 8.62 |
| LBS PER IMP GAL @ 15.6 C. | 10.35 |
| POUR POINT, C. | −26 |
| SPECIFIC GRAVITY @ 15.6 C. | 1.020-1.050 |
| VISCOSITY @ 100 C., CST | 6.5 |
| VISCOSITY @ 40 C., CST | 47.0 |

TABLE 3
Lubrizol 5178F Chemical Properties

| Property | Lubrizol 5178F (wt %) |
|---|---|
| CALCIUM | 0.760-0.920 |
| PHOSPHORUS | 3.53-4.33 |
| SULFATED ASH | 14.40 |
| SULFUR | 7.10-8.70 |
| WATER | 0.30 |
| ZINC | 4.39-5.39 |

According to an exemplary embodiment, an antiwear oil additive other than LUBRIZOL 5178F may be used.

DURASYN 166X may be a hydrocarbon base fluid substantially comprising polyalphaolefin. It may be generally resistant to thermal break down under high temperatures, may permit extended amounts of time to take place between replacement and reapplication cycles, may maintain its viscosity over an extended service life, and may be suitable for exposure to very wide temperature ranges. It may have the following properties:

TABLE 4
Durasyn 166X Properties

| Property | DS-166X |
|---|---|
| Specific Gravity, 15.6° C. (60° F.), g/cc | 0.83 |
| Density, lb/gal | 6.89 |
| Viscosity Index | 137 |
| Viscosity, mm2/s (cSt), 100° C. (212° F.) | 5.9 |
| Viscosity, cSt, mm2/s (cSt), 40° C. (104° F.) | 30.8 |
| Viscosity, mm2/s (cSt), −40° C. (−40° F.) | 7,795 |
| Noack Volatility, 250° C., 1 hr, % wt. | 7.8 |
| Evaporation | |
| Volatility, 205° C., 6.5 hr, % wt. Evaporation | 9.01 |
| Flash Point, ° C., PMCC | 226 |
| Flash Point, ° C., COC | 238 |

A base fluid having similar properties, such as DURASYN 166, may be substituted instead. Alternatively, since DURASYN 166X is engineered for use in a wide variety of applications, a base fluid more tailored to this specific end use may be substituted instead.

CHEVRON PARATONE 68530 may be a linear olefin copolymer that may function as a viscosity improver. It may have the following properties:

TABLE 5
Paratone 68530 Properties

| Property | Paratone 68530 |
|---|---|
| Density, lb/gal | 7.1 |
| Viscosity, mm2/s (cSt), 100° C. (212° F.) | 1600 |
| Viscosity, cSt, mm2/s (cSt), 40° C. (104° F.) | 23000 |
| Flash Point, ° C., PMCC | 150 |
| Shear Stability Index, % | 50 |

Blending may take place using conventional methods for blending finished fluids. Alternative viscosity improvers, for example other CHEVRON PARATONE products, may be used instead. For example, according to an exemplary embodiment, CHEVRON ECA4983 or CHEVRON PARATONE 8259 may be substituted instead.

DOVER CHEMICAL ME 165 may be a low viscosity fatty methyl ester that may function as a lubricity and wetting additive. It offers excellent resistance to oxidative degradation and good chemical compatibility. It may have the following properties:

TABLE 6
ME 165 Properties

| Property | ME 165 |
|---|---|
| Density, lb/gal | 7.26 |
| Viscosity (SUS), 210° F. | 42 |
| Viscosity (SUS), 100° F. | 32 |

Alternatively, a different lubricity and wetting additive, such as another methyl ester wetting agent or a more conventional animal-based fatty additive, may be used instead. For example, according to an alternative exemplary embodiment, DOVER CHEMICAL BASE ML may be substituted instead.

RT VANDERBILT VANLUBE 73 may be a lubricant additive substantially comprising a mixture of metal dialkyldithiocarbamates and functioning as an antioxidant. It may have the following properties:

TABLE 7
Vanlube 73 Properties

| Property | Vanlube 73 |
|---|---|
| 4-Ball Wear (ASTM D 2266), 1200 rpm, | 0.57 |
| 75° C., 40 kgf, 1 h, mm | |
| 4-Ball EP (ASTM D 2596), Weld Point, | 400 |
| kgf | |
| Density at 25° C., Mg/m3 | 1.05 |
| Viscosity, cSt, mm2/s (cSt), 100° C. (212° F.) | 33.34 |
| Viscosity, cSt, mm2/s (cSt), 40° C. (104° F.) | 1.190 |
| Flash Point, ° C., PMCC | 245 |

Alternatively, another antioxidant, such as antimony dialkyldithiocarbamate (SDDC) or sulfurized olefin, may be substituted instead.

BASF SYNATIVE ES2939 may be a polyol ester marketed for use as an additive to jet engine lubricants and offering generally high thermal stability and good oxidation and corrosion resistance. Specifically, BASF SYNTATIVE ES2939 may be a linear chain fatty acid of a pentaerythritol ester. It may have the following properties:

TABLE 8
Synative ES2939 Properties

| Property | Synative ES2939 |
|---|---|
| Viscosity Index | 125 |
| Viscosity, mm2/s (cSt), 100° C. (212° F.) | 5.0 |
| Viscosity, cSt, mm2/s (cSt), 40° C. (104° F.) | 25.4 |
| Flash Point, ° C. | 258 |
| Pour Point, ° C. | −63 |

Alternative polyol ester additives, for example other Synative products, may be substituted instead. For example, according to an exemplary embodiment, a branch chain fatty acid of a pentaerythritol ester, such as EMORY CHEMICAL EM2939 (now out of production) may be substituted instead.

SHEPHERD CHEMICAL BILUBE 8109 may be an extreme pressure and antiwear additive that may largely be composed of bismuth neodecanoate and bismuth carboxylate. According to an exemplary embodiment, another extreme pressure and antiwear additive, such as OMG AMERICAS CATALYST 310, may be substituted instead; an alternative extreme pressure and antiwear additive may have, for example, a different relative composition of bismuth neodecanoate and bismuth carboxylate, or may have an entirely different material composition, as desired.

According to an exemplary embodiment, an anti-friction metal conditioner having the above composition may be added as an additive to motor oil, for example crankcase oil, or to another vehicle oil or lubricant, as desired. For example, according to an alternative exemplary embodiment, an anti-friction metal conditioner having the above composition may be added to transmission fluid, or to gear oil. The quantity of additive that may be added, or the additive-to-oil ratio, may be varied based on, for example, the type of vehicle in question, the age of the vehicle, the wear and tear that the vehicle has experienced, the mileage of the vehicle, or any other relevant criteria, as desired. For example, according to an exemplary embodiment, approximately 10 ounces of anti-friction metal conditioner may be added to the engine oil of a vehicle having an engine oil capacity of between 4.5 and 5.0 quarts. According to such an embodiment, the resulting engine oil may have a composition by volume of anti-friction metal conditioner of between 6.5% and 5.9%. According to another exemplary embodiment, additional anti-friction metal conditioner may be added to an engine per unit volume. According to another exemplary embodiment, less anti-friction metal conditioner may be added to an engine per unit volume. According to another exemplary embodiment, a standard amount of additive, for example 10 ounces, may be added to the oil of a wider range of vehicles, as desired.

According to an exemplary embodiment, an anti-friction metal conditioner may be added to a vehicle as part of the engine oil, and may be mixed in with the engine oil before either the engine oil or the anti-friction metal conditioner is added to the vehicle. According to another exemplary embodiment, an anti-friction metal conditioner may be added to the vehicle's existing engine oil. According to some exemplary embodiments, when the anti-friction metal conditioner has been mixed with engine oil in a vehicle, the vehicle may be driven for some amount of time in order to run the additive more thoroughly into the oil and the metal of the engine parts; for example, the additive may be most effective when the vehicle has been driven for some distance, for example 250 miles or some other distance, with the anti-friction metal conditioner present in the engine oil. According to some other exemplary embodiments, the anti-friction metal conditioner may begin taking effect immediately, and no or substantially no driving of the vehicle may be necessary.

According to an exemplary embodiment, an anti-friction metal conditioner may reduce engine wear as well as reducing friction. Many vehicles, when driven, may experience trace wear in the engine, which may be reflected by a quantity of metal particles, for example aluminum and iron particles, being introduced into the engine oil. According to an exemplary embodiment, a quantity of anti-friction metal conditioner may be added to the engine crankcase of a vehicle, and the vehicle may be driven for a certain distance or period of time. According to such an embodiment, the addition of anti-friction metal conditioner may substantially reduce the amount of wear on the engine, and may reduce or eliminate the introduction of metal particles into the engine oil. In some embodiments, the addition of anti-friction metal conditioner may reduce the introduction of metal particles into the engine oil to the point where metal particles are removed from the engine oil (for example through oxidation) more quickly than they are introduced into the engine oil.

According to an exemplary embodiment, an anti-friction metal conditioner may be added to a vehicle other than in the engine oil, for example as part of another vehicle fluid, oil, or lubricant like transmission fluid or gear oil. According to such an exemplary embodiment, the anti-friction metal conditioner may have the effect of reducing friction and/or wear in another part of the vehicle other than the engine, for example the gears or transmission.

A number of examples demonstrating the performance of an exemplary embodiment of an anti-friction metal conditioner may further be provided.

### Example 1

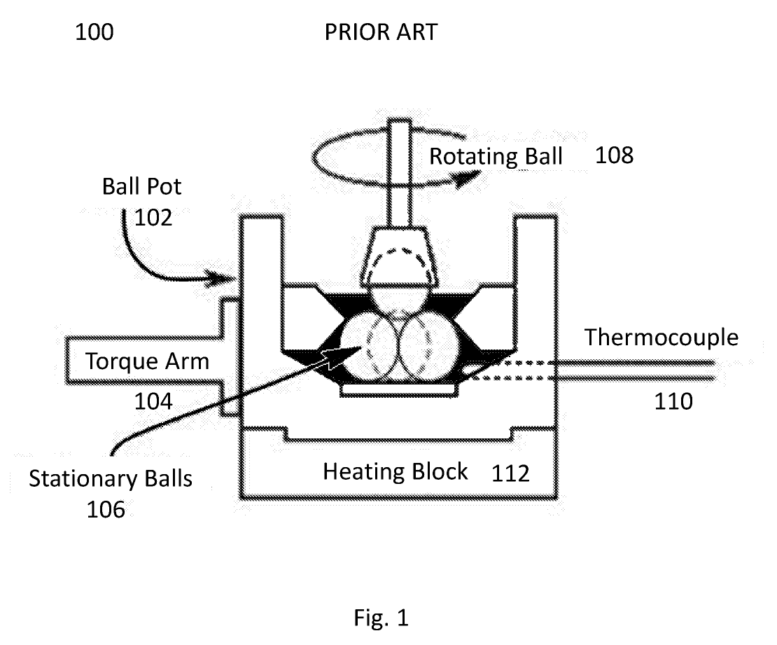

FIG. 1 depicts an exemplary embodiment of the four-ball wear test method 100 that may be used in testing lubricants and lubricant additives. The four-ball wear test method 100, as described by ASTM D2266 and ASTM D4172, may be used to determine the relative wear-preventing properties of lubricating fluids and greases in sliding and rolling applications. Such a method may also be used to determine the coefficients of friction of lubricants according to ASTM D5183. According to such a test method 100, a machine for performing four-ball wear testing 100 may comprise a ball pot 102 that may be filled with lubricant, a torque arm 104 to be used for clamping balls 106 together, a plurality of stationary balls 106 composed of a test metal, a rotating ball 108 that may be rotated on a shaft in contact with the plurality of stationary balls 106, a thermocouple 110 used to monitor the temperature of the lubricant, and a heating block 112 used to maintain the temperature of the lubricant at a particular value. In the test method 100, three small (typically about ½″) halls 106 composed of a test metal may be clamped together and covered with the test lubricant. A fourth ball 108 may be pressed into the cavity formed by the three clamped balls 106 for three point contact, and rotated for a set duration. Lubricants may be compared using the average size of the scar diameters worn on the three lower clamped balls 106.

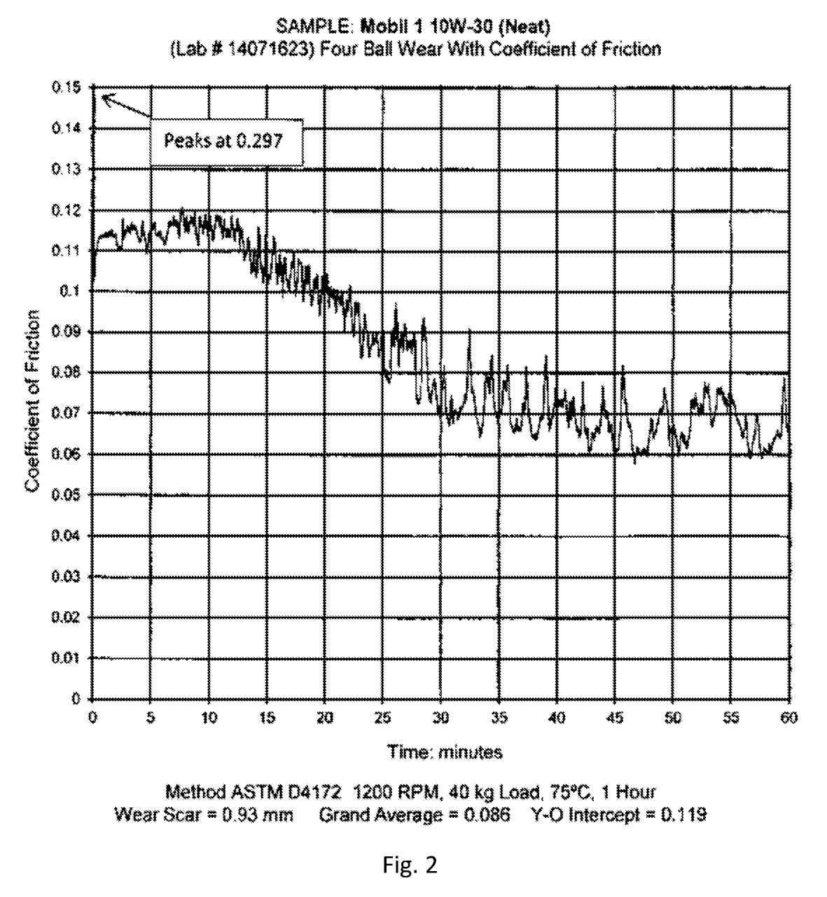

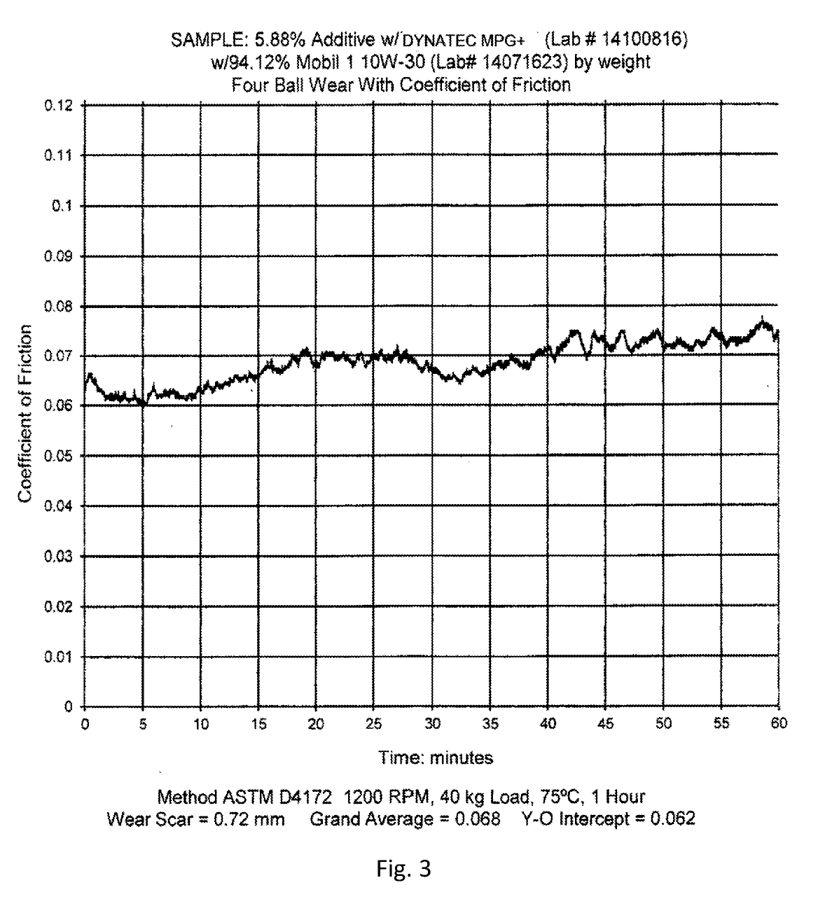

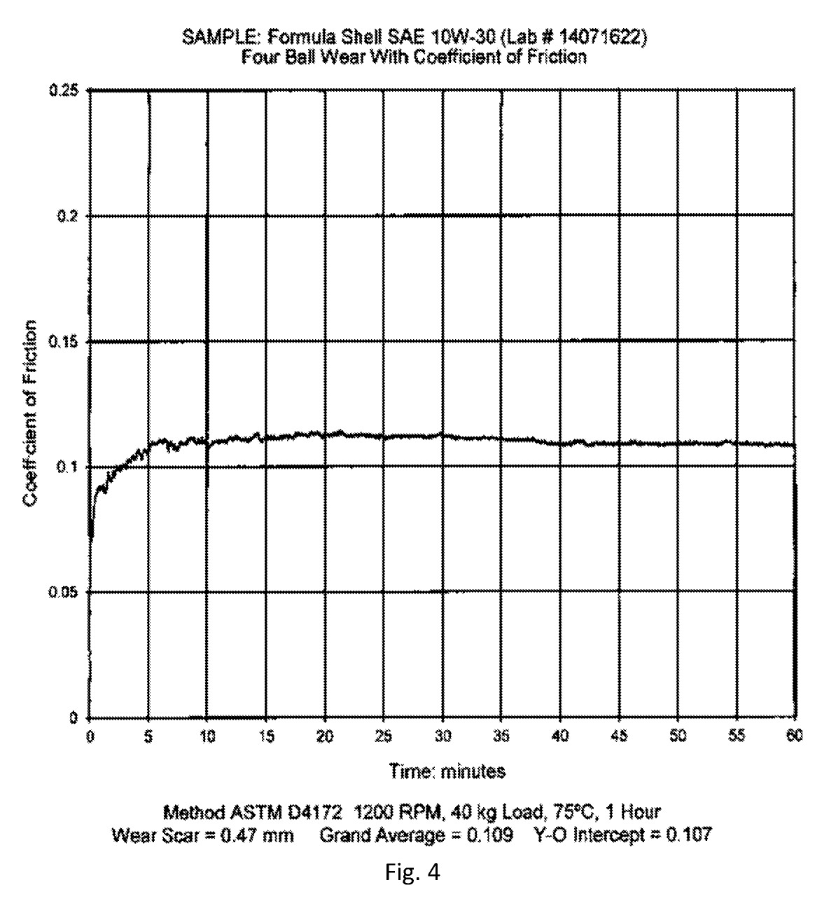

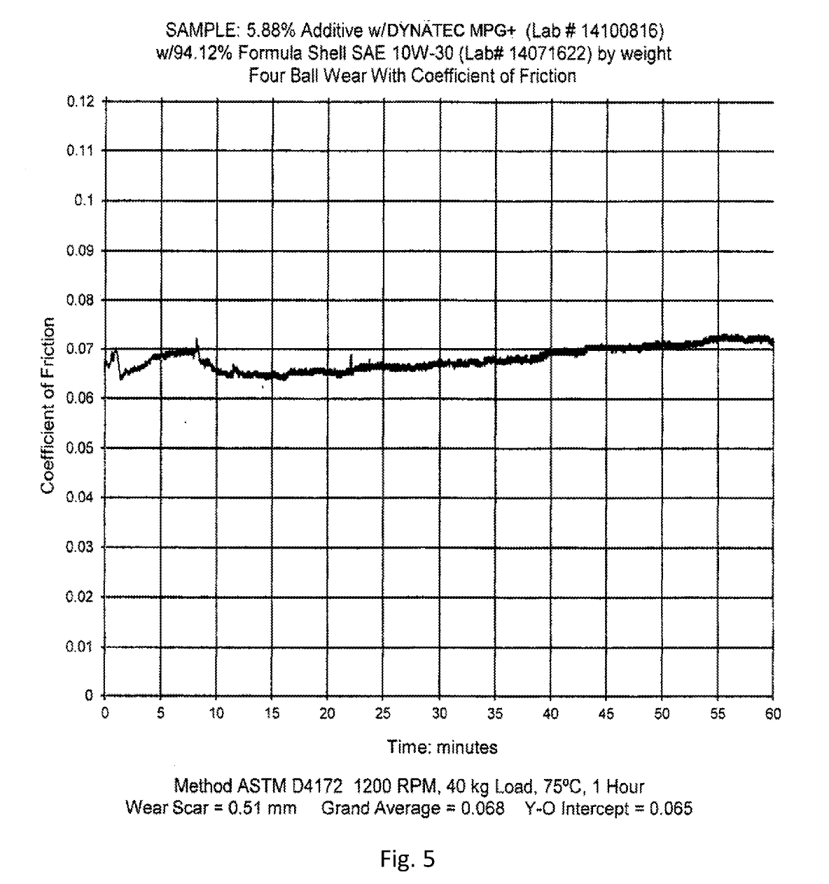

The coefficient of friction test results of two commonly used engine oils with metal conditioner additive as determined by testing those engine oils on a four-ball wear test machine may be provided. Test results for the same brands of engine oils without metal conditioner additive may also be included. FIG. 2 may show the results of a four-ball wear test for MOBIL 1 10W-30 without an anti-friction metal conditioner having been added to the composition, while FIG. 3 may show the results of a four-ball wear test for MOBIL 1 10W-30 with an anti-friction metal conditioner having been added to the composition. FIG. 4 may show the results of a four-ball wear test for SHELL SAE 10W-30 without an anti-friction metal conditioner having been added to the composition, while FIG. 5 may show the results of a four-ball wear test for SHELL SAE 10W-30 with an anti-friction metal conditioner having been added to the composition.

### Example 2

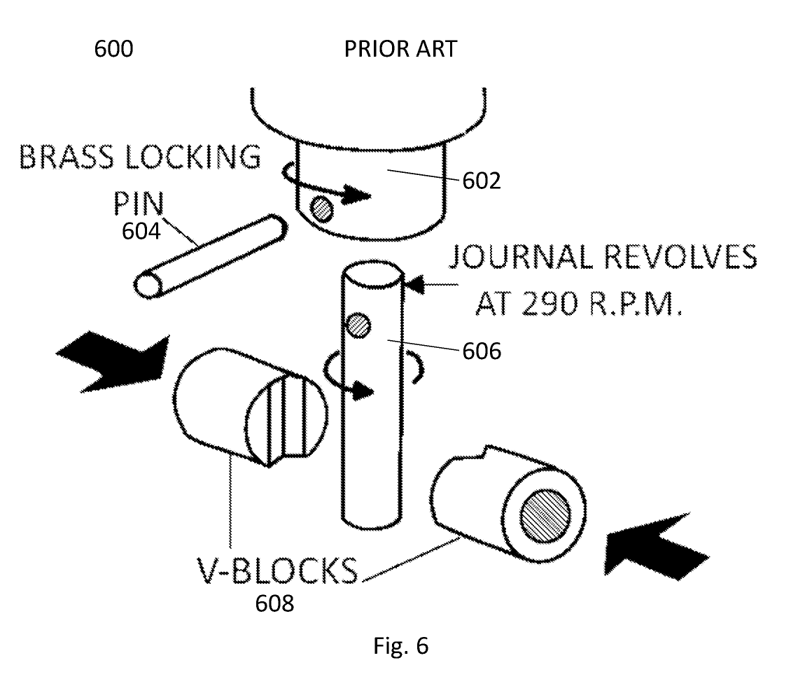

FIG. 6 depicts an exemplary embodiment of an apparatus for performing a Falex Pin and Vee Block Extreme Pressure Test 600. The Falex Pin and Vee Block extreme pressure test 600, as described by ASTM D3233 A, may be used to measure the load carrying ability of an oil. The tribological characteristics measured by the test 600 are most commonly based on the oil's performance in low speed, line contact, steel on steel, sliding motion; however, other materials other than steel on steel may be used in variations of the test. (For the test results provided below, steel on steel was used.)

According to ASTM D3233 A, a Falex Pin and Vee Block Extreme Pressure Test 600 may be conducted by mounting a ¼ inch (6.35 mm) diameter test journal or pin 606 between two ½ inch diameter Vee Blocks 608, each having a V-shaped recess on the axial end with a width similar to that of the test journal or pin 606. The two Vee Blocks 608 surround the test journal 606 while it rotates. The test journal 606 and Vee Blocks 608 are immersed in the oil, preheated to 120° F. (51.7° C.), the Vee Blocks 608 are loaded with a desired load, and the test journal is rotated at a consistent speed of 290 rpm. Test journal or pin 606 may then be connected to an automatic ratchet 602, and a constant increase in load is then applied to the Vee Block 608 pairing by the automatic ratchet 602 until failure as indicated by seizure of the test coupon or rapid loss of load caused by excessive wear.

The extreme pressure test results of a commonly used engine oil, in this case SHELL SAE 10W-30, as determined by testing that engine oil on a Falex Pin and Vee Block test machine may be provided in Table 9. In this test, the test sample was composed of neat oil, with none of the anti-friction metal conditioner additive mixed in with the engine oil.

TABLE 9
Falex Pin and Vee Block Test for Shell SAE 10W-30 (neat)

| Load, lbs | Observed Torque (lb-in) |
|---|---|
| 500 | 13 |
| 750 | 20 |
| 1000 | 28 |
| 1050 | (pin sheared) |

In this test, a break-in load of 300 lbs at 5 minutes was used. A starting torque of 9 lb-in and a final torque of 9 lb-in were observed.

Additional extreme pressure test results may be available for an engine oil composition including an anti-friction metal conditioner additive. The extreme pressure test results of the same engine oil, in this case SHELL SAE 10W-30, including an exemplary embodiment of an anti-friction metal conditioner additive, as determined by testing that engine oil on a Falex Pin and Vee Block test machine may be provided in Table 10. In this test, the test sample was composed of, by weight, 5.88% anti-friction metal conditioner additive and 94.12% SHELL SAE 10W-30 engine oil.

TABLE 10
Falex Pin and Vee Block Test for Shell SAE 10W-30 w. Additive

| Load, lbs | Observed Torque (lb-in) |
|---|---|
| 500 | 12 |
| 750 | 17 |
| 1000 | 34 |
| 1250 | 40 |
| 1500 | 41 |
| 1750 | 43 |
| 2000 | 46 |
| 2250 | 48 |
| 2500 | 49 |
| 2750 | 50 |
| 3000 | 52 |
| 3250 | 53 |
| 3500 | 54 |
| 3750 | 56 |
| 4000 | 58 |
| 4250 | 62 |
| 4500 | 63 |

In this test, a break-in load of 300 lbs at 5 minutes was used. A starting torque of 10 lb-in and a final torque of 9 lb-in were observed.

### Example 3

In another example, a dynamometer test was conducted using a test vehicle. In this example, prior to adding an anti-friction metal conditioner additive, a dynamometer test was performed to determine the horsepower and torque developed by the vehicle. After establishing a baseline, anti-friction metal conditioner additive was added to the crankcase motor oil, the vehicle was driven in order to distribute the additive, and the vehicle was placed back on the dynamometer and tested again.

In this instance, the vehicle used was a 1997 Pontiac Bonneville having 20,478 miles on the vehicle at the start of testing. The vehicle was first tested without the addition of anti-friction metal conditioner additive, and the results of this testing are shown in Table 11. The vehicle was then tested with the addition of anti-friction metal conditioner additive, and the results of this testing are shown in Table 12. Each test had three different iterations.

TABLE 11
Dynamometer test, no additive, iterations 1, 2, and 3.

| | | | Observed |
|---|---|---|---|
| | Observed Horsepower | Observed Horsepower | Horsepower |
| Test RPM | (test 1) | (test 2) | (test 3) |
| 3000 | 75.7 | | 64.2 |
| 4000 | 104.5 | 106.1 | 103.3 |
| 5000 | 119.3 | 117.3 | 117.1 |

TABLE 12
Dynamometer test, with additive, iterations 1, 2, and 3.

| | | | Observed |
|---|---|---|---|
| | Observed Horsepower | Observed Horsepower | Horsepower |
| Test RPM | (test 1) | (test 2) | (test 3) |
| 3000 | 70.5 | 67.5 | 69.9 |
| 4000 | 106.2 | 103.6 | 101.3 |
| 5000 | 124.7 | 125.5 | 128.6 |

In the first test, in which no additive was added to the engine oil, the engine reached a peak temperature of 260° F. and required five minutes to cool down. In the second test, in which metal conditioner additive was added to the engine oil, the engine reached a peak temperature of 240° F. and required two minutes to cool down.

### Example 4

In another example, a dynamometer test was conducted using a test vehicle. In this example, prior to adding an anti-friction metal conditioner additive, a dynamometer test was performed to determine the horsepower, torque, and fuel economy developed by the vehicle. After establishing a baseline, anti-friction metal conditioner additive was added to the crankcase motor oil, the vehicle was driven 250 miles in order to distribute the additive, and the vehicle was placed back on the dynamometer and tested again.

In this instance, the vehicle used was a 2015 Chevrolet Malibu with 15,485 miles on the vehicle at the start of testing. The vehicle was first tested without the addition of anti-friction metal conditioner additive. The vehicle was then tested with the addition of anti-friction metal conditioner additive. The results of this testing are shown in Table 13.

TABLE 13
Dynamometer test, with and without additive.

| Measurement | Without Additive | | With Additive | | Change |
|---|---|---|---|---|---|
| Horsepower (max) | 136.0 | HP | 140.6 | HP | 3.4% |
| Torque (max) | 139.1 | Clb-ft | 146.7 | Clb-ft | 5.5% |
| Fuel Economy | 31.6 | mpg | 34.2 | mpg | 8.2% |

### Example 5

In another example, a dynamometer test was conducted using a test vehicle. In this example, prior to adding an anti-friction metal conditioner additive, a dynamometer test was performed to determine the horsepower, torque, and fuel economy developed by the vehicle. After establishing a baseline, anti-friction metal conditioner additive was added to the crankcase motor oil, the vehicle was driven 250 miles in order to distribute the additive, and the vehicle was placed back on the dynamometer and tested again.

In this instance, the vehicle used was a 1985 Suzuki Samurai with 115,900 miles on the vehicle at the start of testing. The vehicle was first tested without the addition of anti-friction metal conditioner additive. The vehicle was then tested with the addition of anti-friction metal conditioner additive. The results of this testing are shown in Table 14.

TABLE 14
Dynamometer test, with and without additive.

| Measurement | Without Additive | | With Additive | | Change |
|---|---|---|---|---|---|
| Horsepower (max) | 45.0 | HP | 53.8 | HP | 19.56% |
| Torque (max) | 108.6 | Clb-ft | 129.4 | Clb-ft | 19.15% |
| Fuel Economy (city) | 18.86 | mpg | 21.69 | mpg | 15.0% |
| Fuel Economy (hwy) | 25.4 | mpg | 27.8 | mpg | 9.45% |

### Example 6

In another example, an extended engine wear test was conducted. In this instance, an inductively Coupled Plasma Atomic Emission Spectroscopy (CP-AES) test was performed on a number of oil samples taken from a vehicle, over a period of time and mileage. This test is used to detect trace metals.

In this instance, the vehicle used was a 2006 Supercharged Cooper Mini S with 109,585 miles on the vehicle at the start of testing. The vehicle was first tested without the addition of anti-friction metal conditioner additive, and with a fresh change of oil; the vehicle was driven 1,000 miles under these conditions. The vehicle was then tested with the addition of 10 oz of anti-friction metal conditioner additive, and driven similarly large distances. The results of this testing are shown in Table 15.

TABLE 15
Extended engine wear test, with and without additive.

| Miles Driven | | |
|---|---|---|
| (cumulative) | Without Additive | With Additive |
| 0 | No metal flakes present | |
| 1000 | Metal flakes present | |
| | (baseline rate) | |
| 1200 | | Rate of addition of Al flakes at |
| | | 35% of baseline rate |
| | | No accumulation of Fe flakes |
| 2200 | | No accumulation of Al flakes |
| | | Rate of addition of Fe flakes |
| | | at 6% of baseline rate |
| | | Total number of metal flakes |
| | | reduced by 35.8% |
| | | (due to oxidation) |
| 3200 | | Total number of Al flakes |
| | | lower than at 1000-mile mark |
| | | (26% lower) |
| | | Total number of Fe flakes |
| | | lower than at 1000-mile mark |
| | | (15% lower) |

It was further observed that, during the test, the test vehicle experienced an increase in fuel mileage of 21.2%, going from 26.4 to 32.07 miles per gallon when the anti-friction metal conditioner additive was added.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A metal conditioner composition, comprising:
a hydraulic oil additive substantially comprising zinc alkydithiophosphate;
a hydrocarbon base fluid substantially comprising polyalphaolefin;
a viscosity improver substantially comprising a linear olefin copolymer;
a lubricity and wetting additive substantially comprising a low viscosity fatty methyl ester;
an antioxidant;
a polyol ester; and
a mixture of bismuth neodecanoate and bismuth carboxylate.

2. The metal conditioner composition, comprising:
between 0.28 and 0.48 weight percent of the hydraulic oil additive substantially comprising zinc alkydithiophosphate;
between 25.0 and 35.0 weight percent of the hydrocarbon base fluid substantially comprising polyalphaolefin;
between 2.5 and 5.0 weight percent of the viscosity improver substantially comprising a linear olefin copolymer;
between 25.0 and 35.0 weight percent of the lubricity and wetting additive substantially comprising a low viscosity fatty methyl ester;
between 3.5 and 6.5 weight percent of the antioxidant;
between 2.5 and 4.5 weight percent of the polyol ester; and
between 23.0 and 37.0 weight percent of the mixture of bismuth neodecanoate and bismuth carboxylate.

3. The metal conditioner of claim 1, wherein the antioxidant comprises at least one of the set of a metal dialkyldithiocarbamate, antimony dialkyldithiocarbamate, or sulfurized olefin.

4. The metal conditioner of claim 1, wherein the polyol ester comprises at least one of the set of: a linear chain fatty acid of a pentaerythritol ester or a branch chain fatty acid of a pentaerythritol ester.

5. The metal conditioner of claim 1, wherein the metal conditioner is added to engine oil at a ratio of 10 fluid ounces per 4.5 to 5.0 quarts of engine oil.

6. A lubricant composition for a vehicle, comprising:
at least one of engine oil, transmission fluid, or gear oil; and
a metal conditioner composition, the metal conditioner composition comprising:
a hydraulic oil additive substantially comprising zinc alkydithiophosphate;
a hydrocarbon base fluid substantially comprising polyalphaolefin;
a viscosity improver substantially comprising a linear olefin copolymer;
a lubricity and wetting additive substantially comprising a low viscosity fatty methyl ester;
an antioxidant;
a polyol ester; and
a mixture of bismuth neodecanoate and bismuth carboxylate.

7. The lubricant composition of claim 6, wherein the metal conditioner composition comprises:
between 0.28 and 0.48 weight percent of the hydraulic oil additive substantially comprising zinc alkydithiophosphate;
between 25.0 and 35.0 weight percent of the hydrocarbon base fluid substantially comprising polyalphaolefin;
between 2.5 and 5.0 weight percent of the viscosity improver substantially comprising a linear olefin copolymer;
between 25.0 and 35.0 weight percent of the lubricity and wetting additive substantially comprising a low viscosity fatty methyl ester;
between 3.5 and 6.5 weight percent of the antioxidant;
between 2.5 and 4.5 weight percent of the polyol ester; and
between 23.0 and 37.0 weight percent of the mixture of bismuth neodecanoate and bismuth carboxylate.

8. The lubricant composition of claim 6, wherein the antioxidant comprises at least one of the set of: a metal dialkyldithiocarbamate, antimony dialkyldithiocarbamate, or sulfurized olefin.

9. The lubricant composition of claim 6, wherein the polyol ester comprises at least one of the set of: a linear chain fatty acid of a pentaerythritol ester or a branch chain fatty acid of a pentaerythritol ester.

10. The metal conditioner of claim 6, wherein the metal conditioner is added to engine oil at a ratio of 10 fluid ounces per 4.5 to 5.0 quarts of engine oil.

11. A method of decreasing friction and wear in an engine of a vehicle, comprising the step of:
adding to engine oil of the vehicle a metal conditioner composition, wherein the metal conditioner composition comprises:
a hydraulic oil additive substantially comprising zinc alkydithiophosphate;
a hydrocarbon base fluid substantially comprising polyalphaolefin;
a viscosity improver substantially comprising a linear olefin copolymer;
a lubricity and wetting additive substantially comprising a low viscosity fatty methyl ester;
an antioxidant;
a polyol ester; and
a mixture of bismuth neodecanoate and bismuth carboxylate.

12. The method of claim 11, wherein the metal conditioner composition further comprises:
between 0.28 and 0.48 weight percent of a hydraulic oil additive substantially comprising zinc alkydithiophosphate;
between 25.0 and 35.0 weight percent of a hydrocarbon base fluid substantially comprising polyalphaolefin;
between 2.5 and 5.0 weight percent of a viscosity improver substantially comprising a linear olefin copolymer;
between 25.0 and 35.0 weight percent of a lubricity and wetting additive substantially comprising a low viscosity fatty methyl ester;
between 3.5 and 6.5 weight percent of an antioxidant;
between 2.5 and 4.5 weight percent of a polyol ester; and
between 23.0 and 37.0 weight percent of a mixture of bismuth neodecanoate and bismuth carboxylate.

13. The method of claim 11, wherein the antioxidant comprises at least one of the set of:
a metal dialkyldithiocarbamate, antimony dialkyldithiocarbamate, or sulfurized olefin.

14. The method of claim 11, wherein the polyol ester comprises at least one of the set of:
a linear chain fatty acid of a pentaerythritol ester or a branch chain fatty acid of a pentaerythritol ester.

15. The method of claim 11, wherein the step of adding to engine oil a metal conditioner composition further comprises adding the metal conditioner composition to engine oil at a ratio of 10 fluid ounces per 4.5 to 5.0 quarts of engine oil.

16. The method of claim 11, further comprising running the engine to distribute the metal conditioner composition throughout the engine.
